(19) United States
(12) Patent Application Publication
(10) Pub. No.: US 2024/0272601 A1
(43) Pub. Date: Aug. 15, 2024

(54) INDUSTRIAL STEEL PLANT AND CONNECTED MONITORING APPARATUS AND METHOD

(71) Applicant: MORE S.R.L., Gemona del Friuli (IT)

(72) Inventors: Sandro BEORCHIA, Tricesimo (IT); Stefano MORSUT, Tricesimo (IT)

(21) Appl. No.: 18/040,475

(22) PCT Filed: Aug. 4, 2021
(86) PCT No.: PCT/IT2021/050247

§ 371 Date: Feb. 3, 2023

(30) Foreign Application Priority Data
Aug. 4, 2020 (IT) 102020000019078

(51) Int. Cl. G05B 19/05

(52) U.S. Cl. CPC G05B 19/058; G05B 2219/15018; G05B 2219/15117

(57) ABSTRACT

The invention concerns an industrial steel plant comprising one or more components and a monitoring apparatus of data, said data being parameters acquired by detectors and, possibly, control signals to and from control and actuation systems. In particular, the apparatus is suitable to be used to diagnose faults and control industrial steel plants and processes that use a large number of detectors, and comprises a plurality of processing units and a central process unit. The invention also concerns a diagnostic algorithm able to be executed by a monitoring apparatus according to the invention and a method and a monitoring apparatus according to the invention.

### FIELD OF THE INVENTION

Embodiments described here concern an industrial steel plant, and also the connected monitoring method and apparatus of said industrial steel plant.

In particular, the invention is used mainly, but not only, for the diagnosis of faults and malfunctions of the components of an industrial steel plant, and to perform blocking and safety interventions based on the information supplied by a set of distributed detection systems.

The invention is suitable for plants characterized by difficult and sometimes highly dangerous environmental parameters, dangerous both for people and equipment, such as extreme temperatures and/or pressures, presence of corrosive substances or dust, existence of hostile electromagnetic compatibility conditions and other.

The invention can be used in the steel industry for the production of steel or other metals, in which there are, for example, electric arc furnaces, ladles, submerged arc furnaces, melting or refining furnaces, induction furnaces or suchlike, with all their connected equipment to carry out the relative industrial processes.

The invention also concerns a diagnostic algorithm that can be used in the monitoring method and apparatus.

### BACKGROUND OF THE INVENTION

It is known that many industrial processes, in particular those carried out in difficult environments and conditions, have to be constantly monitored, in order to keep the state of the plant, the work parameters, the possible onset of situations of risk for the operators or of damage to the components of the plant under control.

Examples in which continuous monitoring, or monitoring at short intervals, is essential may be the onset of excessive pressures and/or temperatures, the presence of corrosive and/or harmful substances, such as gases, the presence of dust, such as dust from metal materials, which can damage plants and devices and cause significant slowdowns in the production cycle and high costs for maintenance or replacement. These extreme conditions, in the absence of prompt and adequate interventions, can cause damage and breakage of components, machine downtimes, uncontrolled leakages of materials, high risks for the safety of the operators and also other problems.

In advanced plants, surveillance is increasingly delegated to networks and systems of sensors that communicate with one or more operating centers and/or remote acquisition systems.

The electric power supply necessary for the functioning of these systems of sensors and for the transmission of the corresponding measurements takes place mainly by cable. This entails frequent problems in the corresponding measurements, due to damage and breakage of the physical components, such as cables, connectors, conversion and acquisition devices, and suchlike.

For applications where temperatures are high, the cables can overheat or in any case get damaged, changing their electrical impedance and giving rise to measurement errors. Therefore, special fire resistant or cooled conductors must be used, which are expensive and more difficult to install than normal conductors, and sometimes not sufficient to solve the problem.

This also entails a downtime of the machine which, in itself, is another problem.

Other problems may be associated with possible electrical disturbances connected to other user devices that may be near the zone concerned, which make it necessary to study and shield the circuitry and spurious couplings of the cables and devices with the electromagnetic noise usually associated with the presence of high frequency and high power signals, for example in radiofrequency processing plants or in electric arc furnaces.

The problem of electromagnetic noise pollution, or EMC electromagnetic compatibility, with regard to the sensors obviously involves the measuring cables, but also their connections for the electric power supply, since the variation or deviation of the supply voltage in turn causes deviations and fluctuations in the measurement. It is therefore particularly important to reduce both the length of the wired measurement circuits and also the length of the power supply circuits between the unit that processes the measurement and the sensors. The exposure to electromagnetic pollution of the measurement is in fact directly proportional to the length of the circuit.

An alternative solution to wired networks is the use of sensors equipped with battery power and radio frequency communications (wireless or wi-fi). Usually they are organized with a centralized architecture, in which it is provided that the set of detectors communicates with a central processing unit, directly or through an industrial network.

The central processing unit, for example a programmable logic controller (PLC), processes the signals received, recognizes faults thanks to recognition algorithms and prepares the appropriate corrective actions.

One disadvantage of existing systems is the complexity in managing the high number of signals associated with the multiplicity of sensors needed to monitor all the components of the plant. This entails a decrease in efficiency, even in time, in the diagnosis of faults.

Another disadvantage is the energy consumption of these systems, which is higher as the measurement frequency and the speed of transmission of the signal of each sensor/detector to the central processing unit increase. This causes a low duration of the power supply batteries if a high measurement frequency is required to control the process or, at the opposite extreme, the promptness of the control must be sacrificed in favor of the duration of the power supply batteries.

Another problem in known systems is the communication frequency bands, fixed and limited in extension by international norms.

Furthermore, existing commercial devices are often bulky and not suitable for hostile environments; for example, non-refrigerated containers are often used, made of materials that are not suitable for installation on board melting furnaces.

Document US2009062933 describes a system able to detect an anomalous event in an industrial process and to memorize the process data obtained immediately before, during and after the anomalous event. The data memorized can be communicated to an operator, to maintenance personnel or to systems that control or prevent anomalous events.

Document EP0929855 describes an interface device for maintenance use of a process control network for the local diagnosis of the functioning of sensors, for applications in processes such as chemical processes, the processing of petroleum products and suchlike.

The solutions provided in documents US2009062933 and EP0929855 are not particularly suitable in the case of difficult environmental parameters, such as extreme temperatures and/or pressures, the presence of corrosive substances or dust, the existence of hostile electromagnetic compatibility conditions and suchlike.

Document US2014274181 presents an assembly comprising sensor devices or process actuators, a wireless transceiver and a processor. The assembly is suitable to optimize communication resources and the consumption of energy resources, for example based on a fixed day or time, in order to perform activities that require high consumption of the transmission band or of energy. It also provides to manage sensor/actuator activities based on the data detected by other sensors.

There is therefore a need to perfect an industrial steel plant which uses a monitoring apparatus and adopts a method which can overcome at least one of the disadvantages of the state of the art.

In particular, one purpose of the present invention is to make available a more efficient, more resistant and more robust transmission system, also from the point of view of signal management, with regard to hostile environments such as those mentioned above.

One purpose is also to allow a reduction in the number and importance of maintenance and restoration interventions on plants, devices, equipment and suchlike.

Another purpose is to anticipate the intervention before the damage to the component of the plant becomes serious or irreparable, and before situations of risk are created for the operator.

It is also a purpose to increase the efficiency, productivity and safety for the operators of said plants, devices, equipment and suchlike.

Another purpose of the present invention is to provide a monitoring apparatus which allows a simpler management of the signals acquired by a network of detectors, with a lower rate of communication errors.

Another purpose is also to reduce the difficulty, time and high costs for the installation of the monitoring apparatus.

The Applicant has devised, tested and embodied the present invention to overcome the shortcomings of the state of the art and to obtain these and other purposes and advantages.

### SUMMARY OF THE INVENTION

The present invention is set forth and characterized in the independent claims. The dependent claims describe other characteristics of the present invention or variants to the main inventive idea.

In accordance with the above purposes, the embodiments described here concern an industrial steel plant comprising a monitoring apparatus, configured to measure, process and transmit data, able to adopt an innovative method to process and transmit process measurements.

The apparatus and monitoring method are used to diagnose faults, for process supervision and control.

In accordance with some embodiments, the monitoring apparatus is based on a decentralized architecture.

In particular, the monitoring apparatus comprises a plurality of local processing units, each connected on one side to one or more detectors associated with at least one component of the industrial steel plant, and on the other side to a central process unit. With the term component we mean a component selected from a melting furnace, a burner system, cooling systems, electrodes and/or fire protection systems.

Thanks to this decentralized structure, communication mainly occurs between the sensors/detectors associated with one or more components of the industrial steel plant, and the corresponding local processing unit. In particular, the communication can occur at high speed, that is, with a high transmission rate, in order to exchange various control and monitoring data between the sensor or the plurality of sensors and the correlated local processing unit.

In one embodiment, the communication between the various local units and the central unit can, on the other hand, occur with a low or very low transmission rate.

Only when a problem, a condition of risk, a breakdown or other occurs, the local processing unit communicates, now with a high transmission rate communication, the event to the central process unit that has the ability to intervene on the functioning of the specific component, blocking its operation or in any case taking the necessary measures.

In particular, the local processing units are advantageously configured to communicate with the central process unit at a low transmission rate in the presence of a condition that complies with predefined conditions of normal operation, switching instead to high transmission rate communication in the presence of a condition of non-compliance with respect to the predefined conditions, based on parameters detected by a network of detectors.

In this way, data traffic toward the central process unit is significantly reduced, making checks and interventions more timely and efficient.

In one solution of the invention, the processing units as above are connected to the central process unit by means of radio-frequency communication of the wi-fi type.

Advantageously, the monitoring apparatus can also provide a coordination device for a wireless network, able to manage the communication between the processing units and the central process unit. In this way, any conflicts in the management of hardware and/or software resources, such as memory allocations, timing or clock signals and/or suchlike, can be managed effectively even in the case of a large number of local processing units and/or or a very high data flow.

It is also possible, in this way, to reduce the error rate in transmissions, limiting the number of conflicts between communications, waiting times and/or suchlike.

Advantageously, the local processing units are powered autonomously by batteries. In this way, it is possible to avoid using power supply conductors which, in the same way as the signal conductors, may be subject to electromagnetic couplings, which generate EMC-type disturbances associated with the variation or drift of the power supply voltage.

Advantageously, the reduction of data traffic toward the central process unit reduces the power consumption necessary for data transmission, thus making it possible and effective to autonomously power the local processing units by means of batteries.

In addition, the local processing units can also possibly be connected to systems to control and actuate the plants and processes.

According to some embodiments, each local processing unit can vary in a dedicated manner its own reading speed toward the detectors, based on a condition of non-compliance. Advantageously, in this way it is possible to reduce the energy consumption of the detectors and the processing unit. This can also be advantageous in managing the workload of the processing unit, favoring its speed and readiness of calculation.

At the same time, each local processing unit can vary in a dedicated manner the transmission rate of the communication to the central unit depending on the conditions of compliance of the respective process variables. Since data transmission is one of the major causes of energy consumption of the system, the optimization of the transmission rate is one of the main advantages of the system. Reducing the data transmission rate also has a positive effect on the occupation of the communication channel, thus allowing to manage even a very large number of detectors.

### BRIEF DESCRIPTION OF THE DRAWINGS

These and other aspects, characteristics and advantages of the present invention will become apparent from the following description of some embodiments, given as a non-restrictive example with reference to the attached drawings wherein:

FIG. 1 is a schematic representation of an industrial steel plant according to embodiments described here;

FIG. 2 is a block representation of a monitoring apparatus and detectors and control and actuation systems of the plant in FIG. 1;

FIG. 3 is a three-dimensional representation of the plant of FIG. 1;

FIGS. 4A-4E show a sequence relating to a monitoring method in the plant of FIG. 1 according to embodiments described here.

To facilitate comprehension, the same reference numbers have been used, where possible, to identify identical common elements in the drawings. It is understood that elements and characteristics of one embodiment can conveniently be combined or incorporated into other embodiments without further clarifications.

### DETAILED DESCRIPTION OF SOME EMBODIMENTS

We will now refer in detail to the possible embodiments of the invention, of which one or more examples are shown in the attached drawings, by way of a non-limiting illustration. The phraseology and terminology used here is also for the purposes of providing non-limiting examples.

The invention is particularly suitable for applications characterized by difficult environmental parameters, such as extreme temperatures and/or pressures, the presence of corrosive substances or dust, the existence of hostile electromagnetic compatibility conditions and suchlike, in which the integrity of the parts of a transmission system, such as cables, connectors, devices and suchlike can be put at risk.

Examples of such applications can be found in the steel industry for producing steel or other metals, for monitoring casting plants, furnaces or suchlike.

The invention is suitable for use in applications requiring large numbers of detectors, for example because there is the need to keep many different process parameters under control, such as pressures, temperatures, presence of gas, wear, breakages, excessive reductions of thicknesses, localized overheating. Other examples of applications are those of large steel plants with a significant number of components, machines and/or devices and apparatuses, in which it is necessary to use a large number of detectors in order to have a suitable coverage of the parameters of interest. The invention is not substantially limited in its possible applications, although obviously the higher the number of components of the system to be monitored and the more potentially critical the conditions that may occur, the greater its effectiveness.

This text will describe an application relating to the monitoring of components, such as, but not limited to, melting furnaces 51, in industrial steel plants 50 for producing metal materials. It is understood that the present invention is generally applicable to any type of industrial steel plant or process whatsoever, in which there is a need to keep the functioning of several components under control for all the different reasons indicated above.

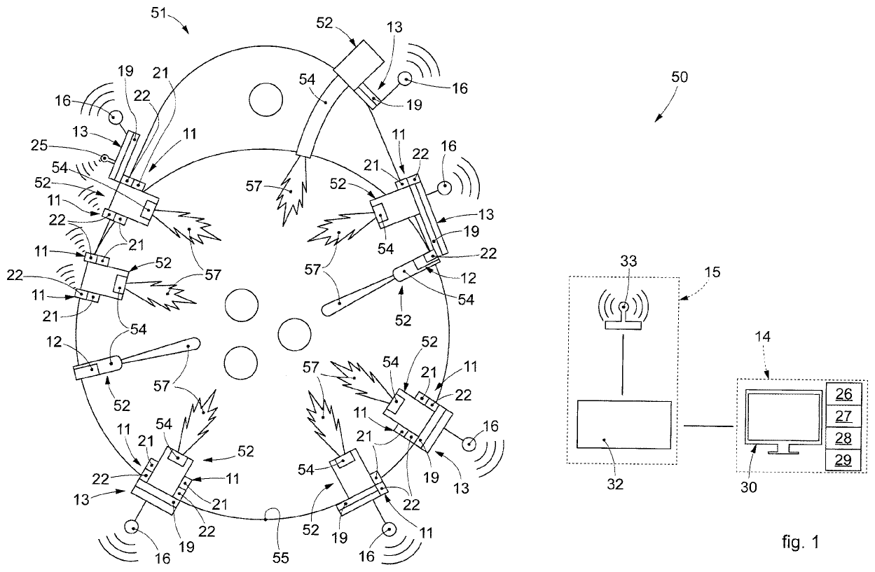

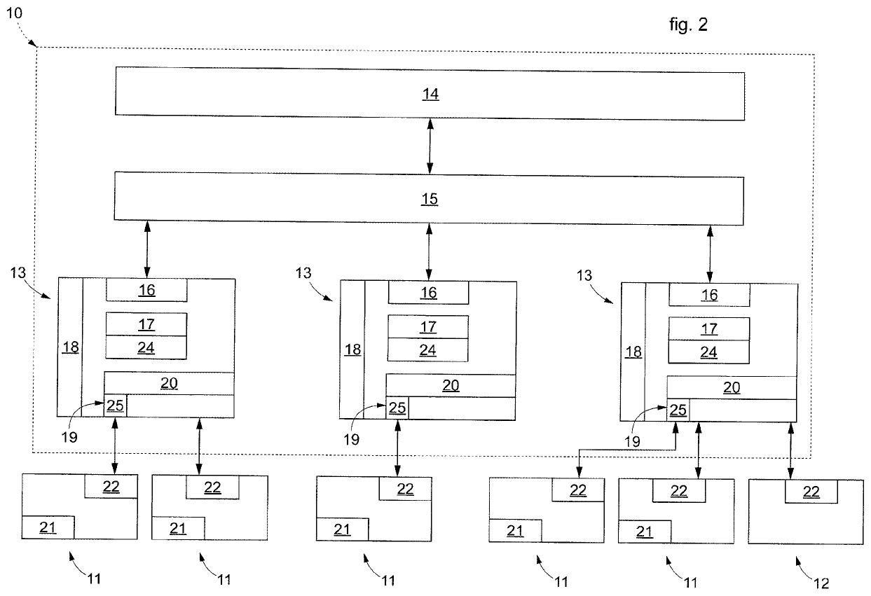

Some embodiments, described by way of example by means of FIGS. 1-3, concern an industrial steel plant 50 comprising a plurality of operating components 51, 52, 53 cooperating with each other in the execution of an industrial steel process, and a monitoring apparatus 10, in particular for monitoring signals acquired by a network of detectors 11, among the components 51, 52, 53 of the plant 50.

In the industrial steel plant 50, the components can be selected from furnaces 51, burner systems 52, cooling systems 53, electrodes, fire protection systems and suchlike.

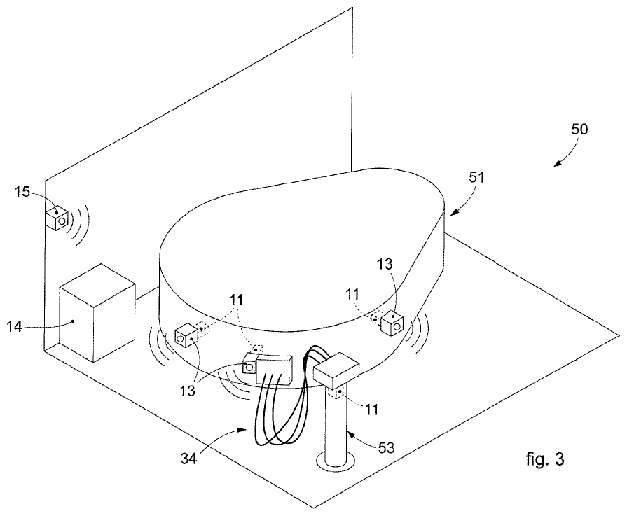

In particular, the plant 50 shown in the example of FIGS. 1 and 3 comprises a furnace 51 for melting metals.

According to some embodiments, the detectors 11 can be sensors, transducers or data detection devices of the direct or indirect type.

In particular, for a furnace 51, the detectors 11 are mainly temperature sensors, level sensors, pressure sensors, sensors for the composition of gases or other fluids.

According to some embodiments, the apparatus 10 can also be suitable to transmit data to and from control and actuation systems 12, such as for example systems 12 for regulating flow rates of fluids, regulating pump revolutions, gas valves or suchlike.

The furnace 51 can have a chamber 55 for containing metal scrap and/or metal and/or glass material 56 being melted and melted.

The plant 50 also comprises burner systems 52, or lances, equipped with water-cooled emission boxes 54 to introduce comburent substances and/or fuels 57 into the furnace 51.

The temperature in the proximity of the walls of the furnace 51 can increase excessively, for example due to backfire phenomena 58, and damage the walls of the chamber 55 and/or the casing of the burner system 52 or of the lance, even though these are internally cooled. The damage can be such as to cause a break in the wall, or casing, with leakage of the cooling liquid, overheating of the burner system 52, and downtime at least of the burner system 52, if not of the furnace 51 and possibly of the plant 50.

Temperature sensors 11 can therefore be positioned in the proximity of the boxes 54 to detect a possible backfire 58. As shown by way of example in FIG. 1, there can be one or more temperature sensors 11 in the proximity of each box 54, preferably two sensors 11. As another example, shown in FIG. 3, one or more temperature sensors 11 can be installed in correspondence with the ducts of the cooling system 53, preferably a single sensor 11.

In accordance with some embodiments, the apparatus 10 is based on a decentralized architecture.

The apparatus 10 provides a plurality of local processing units 13 and at least one central process unit 14. It can also provide a coordination device 15 for a wireless network.

The processing units 13 are connected on one side to one or more corresponding detectors 11, on the other side to the central process unit 14.

According to some embodiments, the processing units 13 are powered autonomously by means of batteries.

According to some embodiments, the data exchanged between the processing unit 13 and the detectors 11 can comprise parameters detected by the detectors 11, data relating to the detectors 11 such as the residual duration of buffer batteries or suchlike, data for managing the detectors 11 such as measurement execution intervals, parameter transmission intervals, sampling frequencies, data processed by the processing unit 13 based on the parameters received from the detectors 11 and/or suchlike.

According to one variant, the processing units 13 can also possibly be connected also to one or more control and actuation systems 12. The data exchanged between the processing units 13 and the possible control and actuation systems 12 can in this case comprise data for regulating plants 50, components 51, 52, 53 of the plants 50, equipment, systems, devices and suchlike managed by the control and actuation systems 12, functioning parameters of the control and actuation systems 12 and/or suchlike.

According to some embodiments, the data exchanged between the processing units 13 and the central process unit 14 can comprise raw parameters detected by the detectors 11, data processed by the processing units 13 based on the parameters received from the detectors 11, alarms or alarm thresholds, possibly data for managing the regulation of control and actuation systems 12, transmission of parameters and/or suchlike.

According to some embodiments, the processing units 13 can comprise one or more of the following devices:
a radio communication system 16;
a programmable logic unit 17;
a source of energy 18 for the electric power supply of the unit 13 itself and possibly of the detectors 11 or the control and actuation systems 12 associated therewith.

Each processing unit 13 can also comprise a container, watertight and/or refrigerated and/or resistant to corrosive substances and/or resistant to overpressures or suchlike, containing the devices as above and any other devices of the processing unit 13, in order to protect them from heat, conductive dust or other harmful substances or conditions.

In the case of a melting furnace 51, the container containing the processing unit 13 can be watertight and refrigerated.

According to some embodiments, the processing units 13 can also comprise an input/output interface 19 for the wired connection 34 of detectors 11 and possibly of control and actuation systems 12.

According to one variant, the input/output interface 19 can allow both a wired communication and also a wireless communication with the detectors 11. It can for example comprise a short-range communication element 25, such as a Bluetooth, infrared device or suchlike, or a long range communication element 25, such as a modem.

The processing units 13 can also comprise an analog-digital interface 20 for interfacing with detectors 11 or possibly with control and actuation systems 12 of the analog type.

The detectors 11 can comprise a sensitive element 21, able to detect the measurement quantity, for example a temperature, a pressure or suchlike.

They can also comprise a device 22 for interfacing the detector 11 with the input/output interface 19 of the processing unit 13. The interfacing device 22 can be able to allow a wired-type communication, for example it can be a connector. It can also be able to allow short or long range wireless communication, for example it can be a Bluetooth, infrared device or suchlike.

According to one variant, the detector 11 and the processing unit 13 can be made within the same device. For example, the processing unit 13 can be a wireless data communication and acquisition card integrated with the detector 11.

Similarly, the control and actuation systems 12 can also comprise a device 22 for interfacing the system 12 with the input/output interface 19 of the processing unit 13.

According to some embodiments, the radio communication system 16 can be short-range, such as a Bluetooth, infrared, Zig-Bee device or suchlike, or long-range, such as a modem or a cellular communication system or suchlike.

According to some embodiments, the radio communication system 16 allows the processing units 13 to communicate with the coordination device 15 of the wireless network.

Possibly, the radio communication system 16 can also be able to allow the processing units 13 to communicate with the interfacing devices 22 of a detector 11 or of a control and actuation system 12.

In an alternative embodiment, the processing unit 13 can communicate with the interfacing devices 22 of a detector 11 and possibly of a control and actuation system 12 by means of the communication element 25 comprised in the input/output interface 19.

According to some embodiments, the processing unit 13 can be able to communicate on bands of different frequencies, depending on whether the communication is toward the central process unit 14 or toward the interfacing devices 22. Advantageously, in this way the occupation times of the frequency bands are reduced. Also advantageously, interferences between the communication channels toward the central process unit 14 and the interfacing devices 22 are also prevented.

The radio communication system 16 can be controlled by means of the programmable logic unit 17.

According to some embodiments, the programmable logic unit 17 can be a microcontroller, a microprocessor, a microcomputer or suchlike.

The processing unit 13 can comprise a storage device 24 on which one or more diagnostic algorithms are installed or can be installed.

The processing unit 13 is able to process the parameters acquired by the detectors 11 and possibly by the control and actuation systems 12 by means of the diagnostic algorithms as above.

Such algorithms can be able to verify the onset of a condition of non-compliance with respect to predefined conditions, such as for example a fault condition, a condition of danger or simply even of non-compliance with predefined reference conditions. The predefined conditions can be related to a quality production standard, and be used for quality control of the work or suchlike.

The programmable logic unit 17 is able to define, or update, a condition of non-compliance, such as a fault.

According to some embodiments, the condition of non-compliance can be defined based on the values of parameters detected by the detectors 11 and possibly by the control and actuation systems 12.

The condition of non-compliance can also be associated with a parameter variation speed different from a predefined speed or speed range. For example, if the absolute value of the parameter falls within a range of predefined values but the speed with which it increases is above a certain threshold, the processing unit 13 can declare a condition of non-compliance.

According to some embodiments, the processing unit 13 is able to vary the transmission rate toward the central process unit 14 based on the condition of non-compliance.

In particular, the programmable logic unit 17 can be able to calculate or vary and manage the transmission rate of the radio communication system 16 with the central process unit 14.

In case of a condition of non-compliance, the programmable logic unit 17 can communicate the data to the central process unit 14 at shorter time intervals, that is, at higher transmission rates, compared to a condition of compliance, in a manner correlated or not with the level of non-compliance.

According to some embodiments, the processing unit 13 is also able to vary the reading frequency of the signals from the detectors 11 by means of the input/output interface 19 based on the condition of non-compliance.

In particular, the programmable logic unit 17 can be able to calculate or vary and manage the reading frequency of the processing unit 13 with the detectors 11.

According to some embodiments, the reading frequency of the signals from the detectors 11 is equal to or higher than the transmission rate toward the central process unit 14.

According to some embodiments, each processing unit 13 communicates with the central process unit 14 in wireless mode by means of the coordination device 15, through a dedicated communication protocol.

The coordination device 15 can be able to manage the communication of the processing units 13 with the central process unit 14.

The coordination device 15 can be able to manage the synchronization of the processing units 13 with the central process unit 14.

The coordination device 15 can comprise one or more data acquisition devices 32 and a communication apparatus 33.

According to some embodiments, the communication apparatus 33 can be able to communicate with the radio communication systems 16 of the processing units 13.

The communication apparatus 33 can be short-range, such as a Bluetooth, infrared, Zig-Bee device or suchlike, or long-range, such as a modem or a cellular communication system or suchlike.

According to some embodiments, the central process unit 14 can be able to manage the entire plant 50 or process, also by cooperating, remotely, with other central process units, with local or remote servers or database systems or with local or internet networks.

The central process unit 14 can be able to manage apparatuses, systems, devices for the normal functioning of the plant 50 or process.

The central process unit 14 can be able to communicate with the processing units 13 and to store and process data, parameters or results of the processing of data and/or parameters for managing the plant 50 or process.

The central process unit 14 can be able to communicate with the control and actuation systems 12 and to store and process data and/or parameters detected by the control and actuation systems 12.

According to a preferred embodiment, the central process unit 14 communicates in wired mode with the control and actuation systems 12 in order to command actions for the normal functioning of the plant 50 or process.

According to some embodiments, the central process unit 14 can command the control and actuation systems 12 in order to implement solutions to carry out operations to restore the predefined conditions.

The control and actuation systems 12 can be able to send, in turn, control signals to apparatuses, systems, devices, components 51, 52, 53 of a plant 50 in order to regulate them. For example, they can command the closing or opening of valves, the stop of an assembly line, the activation of alarm systems and suchlike.

According to one variant, the communication between the central process unit 14 and the control and actuation systems 12 can occur through the processing units 13.

The central process unit 14 can be a programmable logic controller (PLC), a programmable logic process computer (PAC), a server, a custom data processing system or suchlike.

The central process unit 14 can comprise one or more process units 26, or CPUs, one or more electronic memories 27, possibly an electronic database 29 and auxiliary and input/output circuits 28.

For example, the one or more process units 26 can be any form of computer processor whatsoever that can be used to process data advantageously in the field of monitoring and controlling processes and plants 50.

The one or more memories 27 can be connected to the one or more process units 26 and be one or more of those commercially available, such as a random access memory (RAM), a read only memory (ROM), a floppy disc, hard drive, mass storage, or any other form of digital storage whatsoever, local or remote.

Software instructions and the data and/or parameters of the plant 50 and/or of the process can be for example encoded and stored in the one or more memories 27 in order to command the one or more process units 26.

The auxiliary and input/output circuits 28 can be able to interface with external electrical energy supply systems, external data storage systems, subsequent processing systems and suchlike.

The electronic database 29 can be able to store parameters or results of the processing of the parameters detected by detectors 11, for example for purposes of managing the plant 50 or process, quality control, statistical analysis, operator safety management or suchlike.

The central process unit 14 also comprises apparatuses 30 for interfacing with operators of the plant 50 or process, such as for example video terminals, keyboards, mouse, printers and suchlike, through which to display data, enter commands and suchlike for the functioning of the 50 plant or process.

According to some embodiments, some of the processing units 13 can also be connected to one or more other processing units 13, for example in a multi-level hierarchical architecture. Advantageously, the one or more processing units 13 connected between a first processing unit 13 and the central process unit 14 can act as a radio link, or repeater, for transmission, allowing for example data transmission even in the case of large distances between the detectors 11 and the central process unit 14.

According to some embodiments, the intermediate processing units 13 can be able to amplify and/or regenerate the signals, reducing the error rate in communication.

Some embodiments also concern a diagnostic algorithm of a monitoring apparatus 10 according to the invention.

According to some embodiments, the diagnostic algorithm is an algorithm (or computer program or instructions or computer program code) which can be encoded and stored on a storage device 24 and can be readable by a programmable logic unit 17 of a processing unit 13.

According to some embodiments, the diagnostic algorithm can be able to process the parameters collected by detectors 11, recognize and manage conditions of non-compliance, manage the execution of instructions received from a central process unit 14.

According to some embodiments, the diagnostic algorithm can comprise a code for processing parameters communicated by detectors 11, a code for managing statuses of non-compliance and a code for managing instructions received from the central process unit 14.

The parameter processing code can be able to process the parameters communicated by one or more detectors 11, send them to the central process unit 14, prepare them for a comparison with parameters or ranges of parameters relating to predefined conditions or extract additional parameters, such as derivative values over time or group indicators.

The non-compliance status management code can be able to detect whether the parameters and/or the processing results are coherent or not with parameters or ranges of parameters relating to predefined conditions, recognizing conditions of compliance or non-compliance with respect to the predefined conditions.

It can also be able to define and/or vary the transmission rate of the wireless communication of the processing units 13 with the central process unit 14. In particular, it can be able to define a low transmission rate of the wireless communication in a condition of compliance, and a high transmission rate of the wireless communication in a condition of non-compliance.

For example, in the presence of a condition of non-compliance, the data transmission rate toward the central process unit 14 can be increased, compared to the communication transmission rate in conditions of compliance, in a manner proportional to the severity of the event that determines the non-compliance. As another example, in the presence of a condition of non-compliance, the data transmission rate toward the central process unit 14 can be increased by a fixed value.

Optionally, the non-compliance status management code can be able to vary the frequency of detection of the parameters by the detectors 11.

The code for the execution of instructions received from the central process unit 14 can be able to process the instructions and manage them in order to update the detectors 11 and possibly the control and actuation systems 12.

For example, it can command the execution of certain activities by means of the control and actuation systems 12, or update internal parameters of the detectors 11 such as sampling and refresh rates, signal voltage levels and suchlike.

Some embodiments also concern a method to monitor by means of a monitoring apparatus 10 according to the invention.

According to some embodiments, the monitoring method provides to:
detect at least one parameter by means of a corresponding detector 11;
communicate the at least one parameter to at least one processing unit 13 communicating with the corresponding detector 11;
process the at least one parameter by means of the at least one processing unit 13;
based on the processing of the at least one parameter, define a possible condition of non-compliance with respect to predefined reference conditions;
vary the transmission rate of the plurality of processing units 13 with a central process unit 14 based on the existence of a condition of non-compliance;
optionally, vary the frequency of detection of parameters from one or more of the detectors 11 by the plurality of processing units 13 based on the existence of a condition of non-compliance;
communicate, by means of a wireless-type communication, the condition of non-compliance and/or the results of the processing of the parameters acquired by the detectors 11 to the central process unit 14.

According to some embodiments, the monitoring method can provide, in case of a condition of non-compliance, to adjust the communication of one or more of the processing units 13 with the central process unit 14 to the maximum transmission rate.

According to one variant, the monitoring method can provide, in case of a condition of non-compliance, to increase, compare to a condition of compliance, the transmission rate of the communication of one or more of the processing units 13 with the central process unit 14 in a continuous manner, proportionally to a level of non-compliance, or in a discrete manner based on threshold levels of the condition of non-compliance.

According to some embodiments, the monitoring method can provide to adapt the transmission rate of the one or more processing units 13 with the central process unit 14 also based on the specific process and/or plant 50 and/or apparatus.

According to some embodiments, the method can also provide to detect other parameters also from one or more control and actuation systems 12.

According to some embodiments, the method can provide to use diagnostic algorithms stored in the processing unit 13 to process the parameters acquired by the detectors 11 and possibly define a condition of non-compliance.

The method can provide that, in case of a condition of compliance, the processing unit 13 communicates the data to the central process unit 14 at longer time intervals compared to a condition of non-compliance, or suspends communication, or communicates them only periodically at high intervals, in the order of minutes, or at the end of the working of a batch of material, for example for the purpose of updating a central database for statistical or quality control purposes.

The monitoring method can provide that, in case of a condition of non-compliance, the processing unit 13 communicates the data to the central process unit 14 at shorter time intervals compared to a condition of compliance, in a manner correlated or not with the level of non-compliance.

By way of example, communication with the central process unit 14 can occur at intervals of a few fractions of a second, in case of a condition of compliance, and at intervals of a few milliseconds in a condition of non-compliance.

As another example, communication with the central process unit 14 can occur at intervals of a few seconds, in the case of a condition of compliance, and at intervals of a few fractions of seconds in a condition of non-compliance.

As another example, communication with the central process unit 14 can occur at intervals of a few minutes, in the case of a situation of compliance, and at intervals of a few seconds in situations of non-compliance.

As another example, in case of a condition of compliance, communication with the central process unit 14 can be suspended until a condition of non-compliance is detected.

According to some embodiments, the method can provide that the processing unit 13 also varies the reading frequency of the signals from the detectors 11 based on the condition of non-compliance.

The reading frequency of the signals from the detectors 11 can be equal to or higher than the transmission rate with the central process unit 14.

By way of example, the reading frequency of the signals from the detectors 11 can occur at intervals of a few fractions of a second, in the case of a condition of compliance, and at intervals of a few milliseconds in a condition of non-compliance.

By way of another example, the reading frequency of the signals from the detectors 11 can occur at intervals of a few seconds, in the case of a condition of compliance, and at intervals of a few fractions of seconds in a condition of non-compliance.

For example, in the case of monitoring a temperature in a furnace 51, if the temperature values are in a normal range but the speed with which the temperature rises is such that it is possible to quickly reach uncontrollable situations of risk or damage to the furnace 51 itself or to the operators, the processing unit 13 can communicate the data to the central process unit 14 at shorter time intervals than in a normal situation.

According to some embodiments, the monitoring method can provide that the central process unit 14 commands, to one or more control and actuation systems 12, to carry out operations to restore the predefined conditions.

For example, in a furnace 51 it can command to reduce or turn off the burner systems 52 of the furnace 51 or to implement temperature reduction solutions such as increasing the flow of a coolant liquid in the cooling system 53.

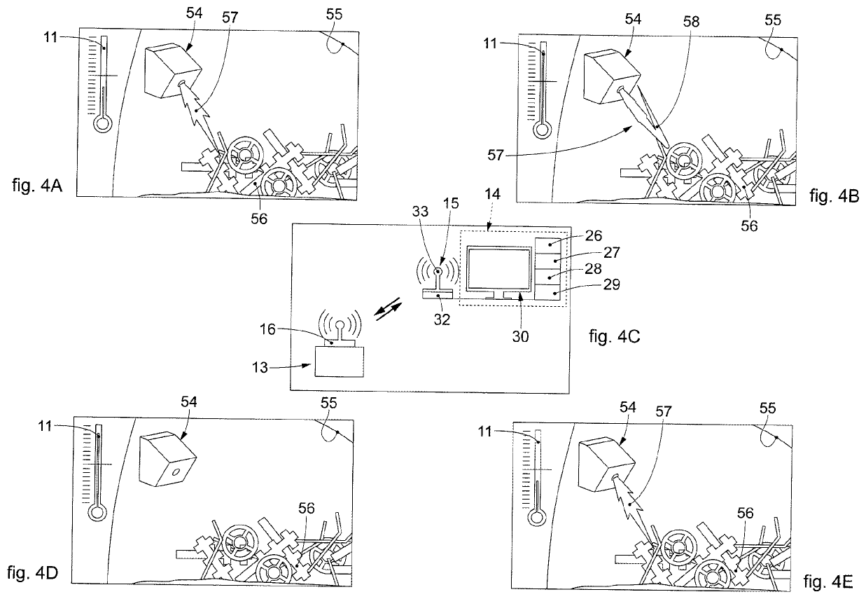

For example, and as shown in FIGS. 4A-4E, in the case of a melting furnace 51, the one or more temperature sensors 11 can detect the temperature in the proximity of the box 54 of the burner system 52.

The one or more temperature sensors 11 can detect an excessive temperature increase, FIG. 4B, due to a backfire 58.

The processing unit 13, FIG. 4C, following the detection of the temperature increase, can communicate with the central process unit 14 a result that identifies (alarm condition) the temperature increase.

The central process unit 14 can then communicate with a control and actuation system 12 a command to shutdown the burner system 52.

The burner system 52 can be shutdown, FIG. 4D, allowing the temperature to decrease.

Following the detection by the temperature sensor 11 of a decrease in temperature, the central process unit 14 can command the re-ignition of the burner system 52 (FIG. 4E).

It is clear that modifications and/or additions of parts or steps may be made to the industrial steel plant 50 comprising one or more components 51, 52, 53 and to the monitoring apparatus 10, to the diagnostic algorithms and to the monitoring method and apparatus 10 as described heretofore, without departing from the field and scope of the present invention as defined by the claims.

In the following claims, the sole purpose of the references in brackets is to facilitate reading: they must not be considered as restrictive factors with regard to the field of protection claimed in the specific claims.

1. An industrial steel plant, comprising one or more components, selected from a melting furnace, a burner system, electrode cooling systems and fire protection systems, wherein it also comprises a monitoring apparatus having a decentralized architecture comprising:
a plurality of local processing units, each communicating with at least one corresponding detector which is associated with at least one of said components; wherein said detectors are selected from temperature sensors, level sensors, pressure sensors, sensors for the composition of gasses or other fluids;
and
a central process unit;
said processing units being configured to acquire at least one parameter relating to at least one of said components and detected by the corresponding detector, and to recognize conditions of non-compliance which are communicated to said central process unit.

2. The plant as in claim 1, wherein said local processing units are configured to communicate with said central process unit at a low transmission rate in the presence of a condition of compliance, and at a high transmission rate in the presence of a condition of non-compliance.

3. The plant as in claim 1, wherein said local processing units are connected to the central process unit by means of wireless communication.

4. The plant as in claim 1, wherein said local processing units are autonomously powered by batteries.

5. The plant as in claim 3, wherein characterized in that it comprises a device for coordinating a wireless network able to manage the connection of said local processing units to the central process unit.

6. The plant as in claim 1, wherein said processing unit is a wireless data acquisition and communication card integrated with a corresponding detector.

7. The plant as in claim 1, wherein said local processing units are connected to the corresponding detectors by means of wired and/or wireless communication.

8. The plant as in claim 1, wherein each of said local processing units also comprises a radio communication system and a programmable logic unit able to execute said diagnostic algorithms.

9. The plant as in claim 1, wherein at least part of said local processing units are connected in a two or more level hierarchical architecture with one or more other local processing units, wherein the one or more local processing units connected between a first local processing unit and the central process unit is able to execute a radio link function.

10. The monitoring apparatus comprised in an industrial steel plant according to claim 1, wherein it has a decentralized architecture comprising:
a plurality of local processing units; and
at least one central process unit.

11. The diagnostic algorithm able to be executed by a monitoring apparatus as in claim 10, said algorithm being stored on a storage device and readable by a programmable logic unit of a local processing unit, comprising:
a code for processing parameters communicated by detectors;
a code for managing non-compliance statuses with respect to predefined conditions;
wherein the non-compliance status management code is able to recognize conditions of compliance or non-compliance with respect to predefined conditions based on the coherence of at least one parameter and/or the results of the processing of the parameters with said predefined conditions.

12. The algorithm as in claim 11, wherein characterized in that the non-compliance status management code is able to define a low transmission rate of the wireless communication of a plurality of local processing units with a central process unit associated with a said condition of compliance, and a high transmission rate of the wireless communication associated with a said condition of non-compliance.

13. The monitoring method in an industrial steel plant as in claim 1, wherein it provides to:
detect at least one parameter by means of a corresponding detector;
communicate said at least one parameter to at least one local processing unit communicating with said corresponding detector;
process said at least one parameter by means of said at least one local processing unit;
define a possible condition of non-compliance;
based on the verification of a condition of non-compliance, communicate said condition of non-compliance to a central process unit.

14. The method as in claim 13, wherein it also provides to communicate with said central process unit at a low transmission rate in the presence of a condition of compliance, and at a high transmission rate in the presence of a condition of non-compliance.

15. The method as in claim 13, wherein it provides that said local processing units and the central process unit communicate via wireless type communication.

16. The method as in claim 13, wherein it provides that the frequency of detection of parameters by one or more of said detectors to one or more of said local processing units is varied based on the existence of a condition of non-compliance.

17. The method as in claim 13, wherein it provides that the central process unit commands one or more control and actuation systems to carry out operations for restoring the predefined conditions.
